(19) United States
(12) Patent Application Publication
(10) Pub. No.: US 2013/0018949 A1
(43) Pub. Date: Jan. 17, 2013

(54) DYNAMIC NEWS MEDIA SELECTION FOR SOCIAL NETWORK DISTRIBUTION

(71) Applicant: Anantha Pradeep, Piedmont, CA (US)

(72) Inventor: Anantha Pradeep, Piedmont, CA (US)

(21) Appl. No.: 13/183,428

(22) Filed: Jul. 14, 2011

(51) Int. Cl. G06F 15/16

(52) U.S. Cl. 709/204

(57) ABSTRACT

Attributes associated with an entity such as a brand, product, or service are identified from analysis of the entity itself as well as from information from an entity owner such as a company or firm. Attributes and news articles are transmitted over a network. News articles exhibiting characteristics promoting identified attributes are selected and conveyed back over the network. The news articles are then posted on social network walls and profiles of pages of interested individuals. Entities may identify interested individuals as those who have joined, followed, liked, or subscribed to a particular entity page. Interested individuals may also be identified through their profile characteristic information.

### TECHNICAL FIELD

The present disclosure relates to selecting news articles for social network distribution.

### DESCRIPTION OF RELATED ART

Social networks provide a convenient mechanism for entities such as companies to connect with interested individuals such as customers and clients. These individuals can often be easily identified. Interested individuals including customers, clients, followers, fans, etc., often select a particular entity such as a brand to connect with in social networks. For example, frequent customers of a brand may select the brand to follow, join, or like. The social networks provide a efficient way for entities to connect with interested individuals. A company brand social network profile may provide information about new products, offers, events, etc. that are then posted to customer profile pages or customer walls. A brand page may also provide contests, rewards, loyalty points, etc., to customers.

Customers may also be rewarded for referring friends and family to a brand or entity page. Deals may be received only after a certain number of friends and family have been referred. However, mechanisms for using the connection between entity pages such as company brand pages and interested individuals are limited. Consequently, it is desirable to provide improved mechanisms for using the connection between entity pages and interested individuals in social networks.

### SUMMARY

Attributes associated with an entity such as a brand, product, or service are identified from analysis of the entity itself as well as from information from an entity owner such as a company or firm. Attributes and news articles are transmitted over a network. News articles exhibiting characteristics promoting identified attributes are selected and conveyed back over the network. The news articles are then posted on social network walls and profiles of pages of interested individuals. Entities may identify interested individuals as those who have joined, followed, liked, or subscribed to a particular entity page. Interested individuals may also be identified through their profile characteristic information.

### BRIEF DESCRIPTION OF THE DRAWINGS

The disclosure may best be understood by reference to the following description taken in conjunction with the accompanying drawings, which illustrate particular embodiments of the present invention.

FIG. 1 illustrates a particular example of a system that can use the techniques and mechanisms of the present invention.

FIG. 2 illustrates a technique for selecting new content for social media distribution.

FIG. 3 illustrates one example of a news article an brand attribute mapping.

FIG. 4 illustrates a particular example of a computer system.

### DETAILED DESCRIPTION

Reference will now be made in detail to some specific examples of the invention including the best modes contemplated by the inventors for carrying out the invention. Examples of these specific embodiments are illustrated in the accompanying drawings. While the invention is described in conjunction with these specific embodiments, it will be understood that it is not intended to limit the invention to the described embodiments. On the contrary, it is intended to cover alternatives, modifications, and equivalents as may be included within the spirit and scope of the invention as defined by the appended claims.

For example, the techniques and mechanisms of the present invention will be described in the context of particular social networks. However, it should be noted that the techniques and mechanisms of the present invention apply to a variety of different social networks. In the following description, numerous specific details are set forth in order to provide a thorough understanding of the present invention. Particular example embodiments of the present invention may be implemented without some or all of these specific details. In other instances, well known process operations have not been described in detail in order not to unnecessarily obscure the present invention.

Various techniques and mechanisms of the present invention will sometimes be described in singular form for clarity. However, it should be noted that some embodiments include multiple iterations of a technique or multiple instantiations of a mechanism unless noted otherwise. For example, a system uses a processor in a variety of contexts. However, it will be appreciated that a system can use multiple processors while remaining within the scope of the present invention unless otherwise noted. Furthermore, the techniques and mechanisms of the present invention will sometimes describe a connection between two entities. It should be noted that a connection between two entities does not necessarily mean a direct, unimpeded connection, as a variety of other entities may reside between the two entities. For example, a processor may be connected to memory, but it will be appreciated that a variety of bridges and controllers may reside between the processor and memory. Consequently, a connection does not necessarily mean a direct, unimpeded connection unless otherwise noted.

Social networks provide convenient mechanisms for an entity such as a company brand to directly connect with consumers. According to various embodiments, brand pages will provide offers, event announcements, product information, etc., about brand products and services. The information may be automatically posted to the walls and profiles of interested individuals. These interested individuals may include customers, clients, fans, etc., that joined, subscribed, liked, or followed a particular brand page. In particular embodiments, an interested individual may be customer who may like or follow a particular brand page. The brand page may provide coupons, offers, product information, etc., on the customer's profile or wall. The coupons, offers, product information, etc., may be visible to the customer only or to the customer as well as the customer's social network.

In many instances, connections between a brand page and a customer are particularly effective connections because they are voluntary and attract the most ardent customers who are most likely to advocate for the particular brand. Nonetheless, entities often have difficulty selecting material to provide to interested parties. Providing too much extraneous information may prompt a previously interested party to stop following or unsubscribe a particular entity page. Providing too little information may underutilize the connection between the brand page and the customer.

Consequently, the techniques and mechanisms of the present invention provide another mechanism for enhancing the connection between an entity, such as a brand, and an interested individual, such as a brand page follower. According to various embodiments, brand attributes are identified. For example, a technology brand may have associated attributes such as innovative, reliable, and fast. A household cleaner brand may have associated attributes such as fresh, clean, and good value. In particular embodiments, news articles having attributes corresponding to a brand are identified and selected for distribution through the brand page's social network According to various embodiments, a news selection system receives brand attribute information, news articles, and provides the news articles and brand attribute information so that matches can be found between news articles and brand attributes.

In particular embodiments, matching can be done manually or automatically. Filtering analysis can then be applied to select a particular number of the most closely corresponding articles to provide to the user at selected times. According to various embodiments, the frequency at which news articles are posted depends upon the level of interest the user has exhibited in the entity social network page. In particular embodiments, the level of interest is identified based on the amount of time the user has spent viewing a brand page or reading articles associated with the brand page. Level of interest may also be determined based on the user's interest in other activities, pages, and sites that can be associated with the brand. News articles are then posted to the customer's wall or profile and may be viewable by the customer only or the customer and the customer's social network.

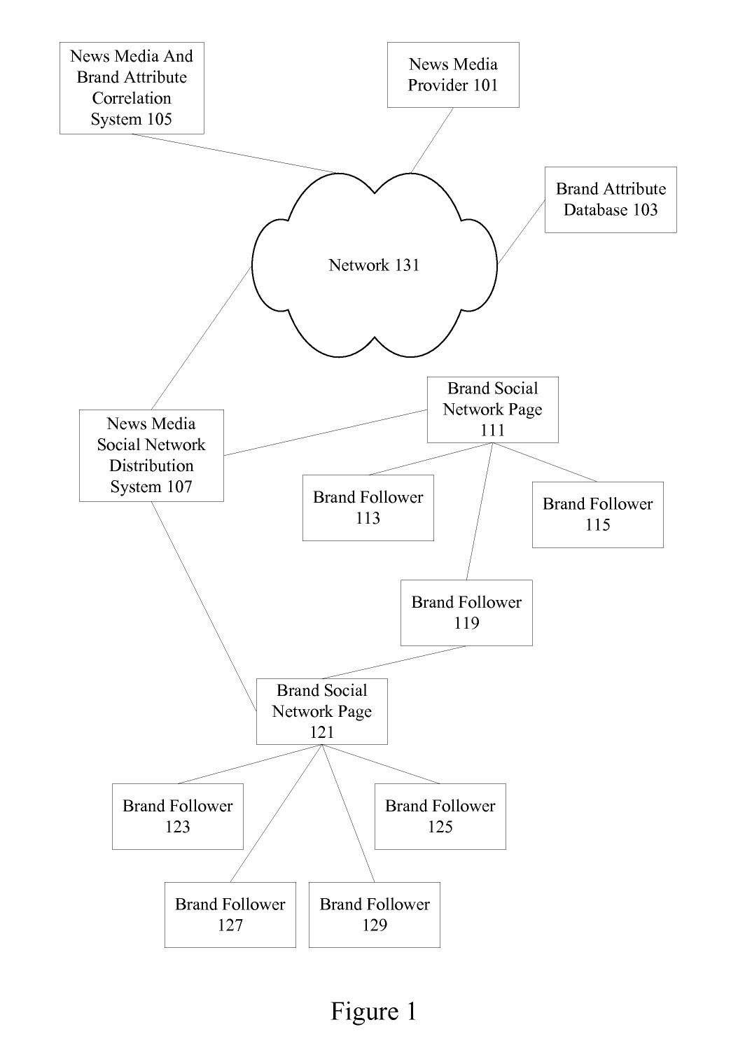

FIG. 1 illustrates one example of a system that can use the techniques and mechanisms of the present invention. According to various embodiments, companies, firms, organizations, etc., may have social network pages such as brand pages 111 and 121 that allow customers, followers, fans, etc., to connect with the brands. A particular brand page may post offers, coupons, product announcements, etc., on brand follower pages such as brand follower pages 113, 115, 119, 123, 125, 127, and 129.

According to various embodiments, entities such as companies, organizations, firms, etc., provide attributes for inclusion in a brand attribute database 103. Brand X may have attributes of reliable and clean. Brand Y may have attributes of high quality but expensive. These attributes may be identified by entities themselves or by brand followers. According to various embodiments, the attributes are attributes that an entity desires to have associated with a particular brand. The brand attribute database 103 may be automatically or manually populated. In particular embodiments, a news media provider 101 sends news articles, clips, and videos over a network 131 to a news media and brand attribute correlation system 105 over a network. The news media and brand attribute correlation system 105 selects news articles and news materials that correspond with particular brand attributes. According to various embodiments, an article may evoke feelings of closeness and trust. The article may be matched with brands desiring association with the attributes of closeness and trust. In particular embodiments, news articles and new materials are manually selected for particular brand attributes or particular brands. According to various embodiments, new articles are rated for correspondence to a particular brand or brand attributes. A company may purchase rights to distribute a particular percentage of those articles using a news media social network distribution system 107.

According to various embodiments, a company purchases rights to distribute the three most highly rated articles every week based on brand attributes provided by the company. According to various embodiments, news articles are selected not only for correspondence or promotion of brand attributes, but also for correspondence to follower profile characteristics. Selected news articles may be provided to particular groups of followers. In particular embodiments, some articles may be more effective at promoting brand attributes for particular demographic groups.

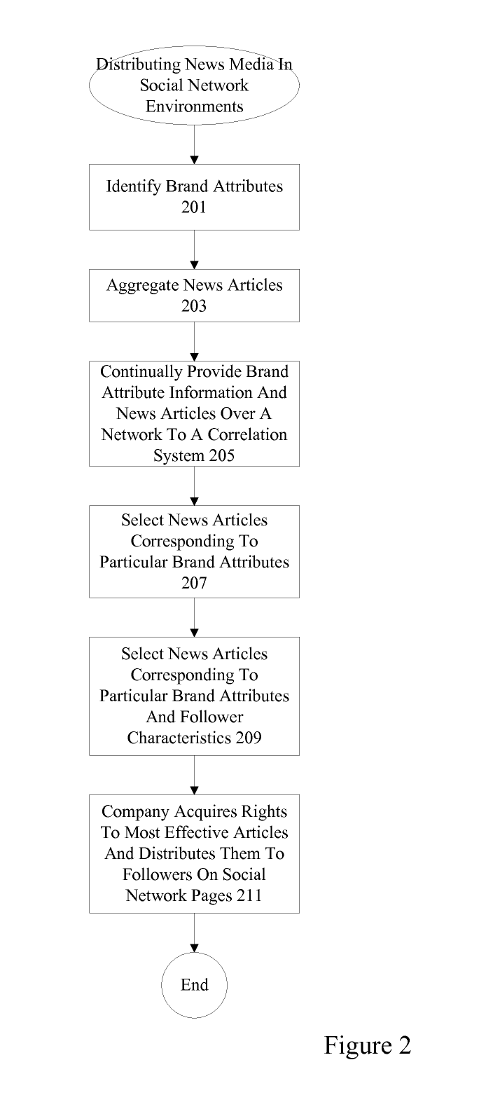

FIG. 2 illustrates one example of a technique for distributing news media in social network environments. According to various embodiments, brand attributes are identified at 201. Brand attributes may be manually or automatically identified. News articles are aggregated at 203. In particular embodiments, brand attributes and news articles are continually provided over a network to a news media and brand attribute correlation system at 205. Correlation of news articles and brand attributes may be performed manually or automatically. At 207, news articles corresponding to particular brand attributes are selected. At 209, news articles corresponding to particular brand attributes effective for followers having particular characteristics such as demographic and viewing characteristics are identified. At 211, a company selects the most effective articles and distributes them to followers on social network pages. The distribution may entail posting articles on the walls of followers. These articles may be accessible by brand followers only or to followers as well as their friends and family.

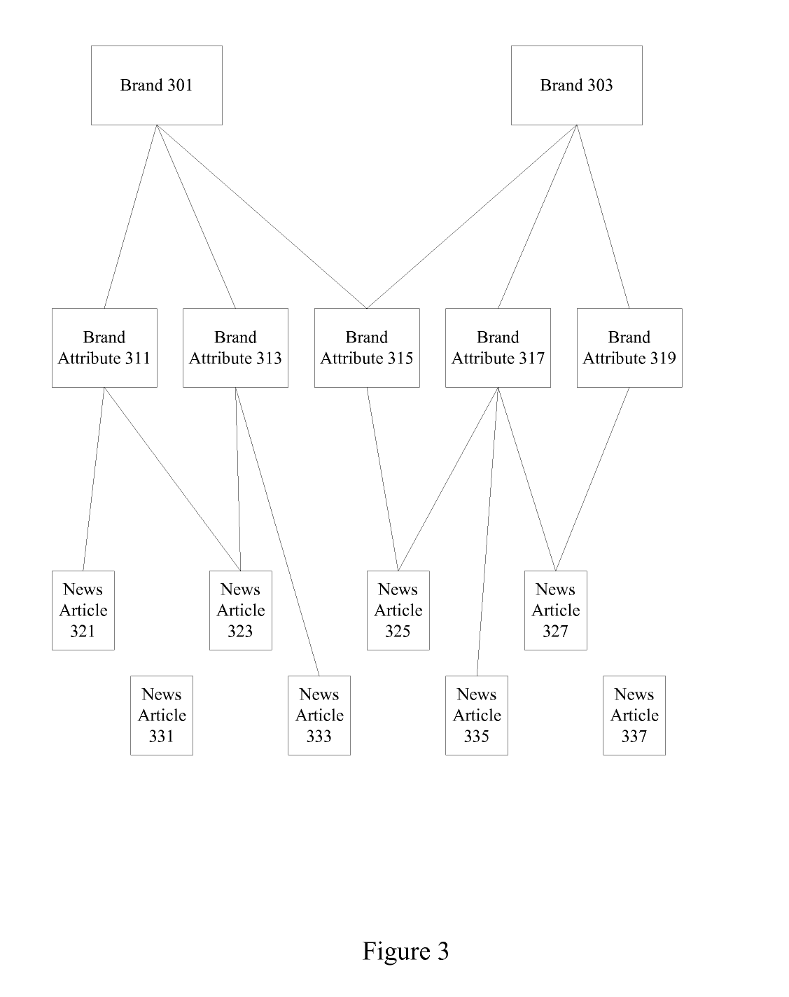

FIG. 3 illustrates one example of a brand attribute and news article mapping. A brand 301 may have brand attributes 311, 313, and 315. Brand 303 may also have brand attribute 315 along with brand attributes 317 and 319. Brand attributes may be characteristics like reliable, dependable, clean, value oriented, refreshing, healthy, etc. These brand attributes may be identified by companies, individuals, organizations, groups, etc.

According to various embodiments, brand attributes 311, 313, 315, 317, and 319 and news articles 321, 323, 325, 327, 331, 333, 335, and 337 are provided over a network so that news articles 321, 323, 325, 327, 331, 333, 335, and 337 can be evaluated for correspondence to brand attributes. Correspondence may include a news articles ability to promote a particular brand attribute or delineate how the brand owner is exhibiting the particular brand attribute. For example, a news article about a vehicle with an odometer reaching 350,000 miles may promote the brand attribute of reliability for the vehicle brand owner. This news article may be flagged with high value rating or high correspondence to the brand attribute of reliability. The same news article may also correspond to the brand attributes of loyalty, quality, durability, etc., although at different value ratings.

In particular embodiments, news article 321 is marked as corresponding to brand attribute 311. News article 321 may be given a value rating indicating how closely it corresponds to brand attribute 311. News article 323 may correspond to both brand attributes 311 and 313. News article 325 may correspond to brand attributes 315 and 317. News article 327 may correspond to brand attributes 317 and 319. News article 333 may correspond to brand attribute 313. News article 335 may correspond to brand attribute 317. News articles 331 and 337 may not correspond with any brand attributes. News articles may be mapped to brand attributes manually or automatically. According to various embodiments, news articles are continuously received and mapped to existing brand attributes. Alternatively, mapping can be done periodically or at particular predetermined times.

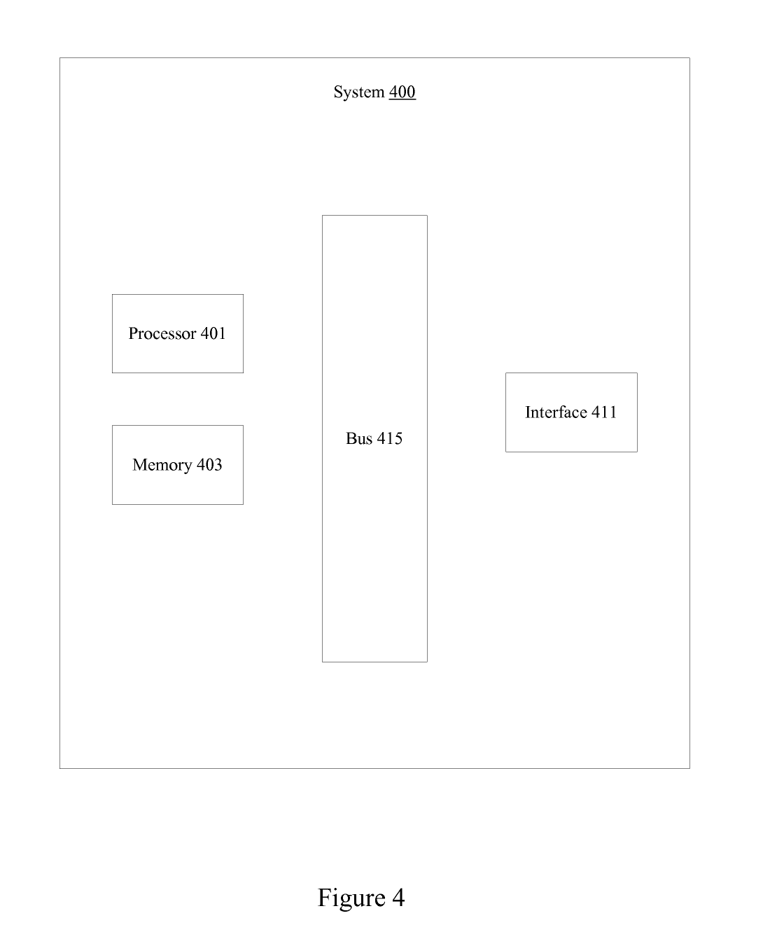

A variety of devices and applications can implement particular examples of the present invention. FIG. 4 illustrates one example of a computer system that can be used to implement various operations associated with the present invention. According to particular example embodiments, a system 400 suitable for implementing particular embodiments of the present invention includes a processor 401, a memory 403, an interface 411, and a bus 415 (e.g., a PCI bus). When acting under the control of appropriate software or firmware, the processor 401 is responsible for such tasks such as optimization. Various specially configured devices can also be used in place of a processor 401 or in addition to processor 401. The complete implementation can also be done in custom hardware. The interface 411 is typically configured to send and receive data packets or data segments over a network. Particular examples of interfaces the device supports include Ethernet interfaces, frame relay interfaces, cable interfaces, DSL interfaces, token ring interfaces, and the like.

In addition, various very high-speed interfaces may be provided such as fast Ethernet interfaces, Gigabit Ethernet interfaces, ATM interfaces, HSSI interfaces, POS interfaces, FDDI interfaces and the like. Generally, these interfaces may include ports appropriate for communication with the appropriate media. In some cases, they may also include an independent processor and, in some instances, volatile RAM. The independent processors may control such communications intensive tasks as packet switching, media control and management.

According to particular example embodiments, the system 400 uses memory 403 to store data and program instructions and maintained a local side cache. The program instructions may control the operation of an operating system and/or one or more applications, for example. The memory or memories may also be configured to store received metadata and batch requested metadata.

Because such information and program instructions may be employed to implement the systems/methods described herein, the present invention relates to tangible, machine readable media that include program instructions, state information, etc. for performing various operations described herein. Examples of machine-readable media include hard disks, floppy disks, magnetic tape, optical media such as CD-ROM disks and DVDs; magneto-optical media such as optical disks, and hardware devices that are specially configured to store and perform program instructions, such as read-only memory devices (ROM) and programmable read-only memory devices (PROMs). Examples of program instructions include both machine code, such as produced by a compiler, and files containing higher level code that may be executed by the computer using an interpreter.

Although many of the components and processes are described above in the singular for convenience, it will be appreciated by one of skill in the art that multiple components and repeated processes can also be used to practice the techniques of the present invention.

While the invention has been particularly shown and described with reference to specific embodiments thereof, it will be understood by those skilled in the art that changes in the form and details of the disclosed embodiments may be made without departing from the spirit or scope of the invention. It is therefore intended that the invention be interpreted to include all variations and equivalents that fall within the true spirit and scope of the present invention.

What is claimed is:

1. A method, comprising:
identifying a plurality of brand attributes associated with a brand;
receiving a plurality of news articles;
sending the plurality of brand attributes and the plurality of news articles over a network to a news article and brand attribute correlation system, wherein the news article and brand attribute correlation system identifies particular news articles corresponding to particular brand attributes;
sending selected news articles to a news media social network distribution system, wherein the news article social network distribution system posts the selected news articles to pages of followers of the brand.

2. The method of claim 1, wherein followers of the brand comprise individuals who have joined, followed, liked, or subscribed to a brand page.

3. The method of claim 1, wherein the plurality of brand attributes comprise a plurality of desired attributes for the brand.

4. The method of claim 1, wherein the plurality of news articles comprise text and photos.

5. The method of claim 1, wherein news articles corresponding to particular brand attributes are manually selected.

6. The method of claim 1, wherein news articles address topics not directly related to the brand.

7. The method of claim 1, wherein particular news articles are identified based not only on correspondence to particular brand attributes but effectiveness in portraying the brand attributes to a particular demographic profile.

8. The method of claim 7, wherein different news articles are selected for different groups of people for the same brand.

9. The method of claim 1, wherein the plurality of brand attributes are identified by a company.

10. The method of claim 1, wherein the plurality of brand attributes are identified by followers of the brand.

11. A system, comprising:
a processor configured to identify a plurality of brand attributes associated with a brand;
memory configured to maintain a plurality of news articles;
an interface configured to send the plurality of brand attributes and the plurality of news articles over a network to a news article and brand attribute correlation system, wherein the news article and brand attribute correlation system identifies particular news articles corresponding to particular brand attributes;
wherein selected news articles are sent to a news media social network distribution system, wherein the news article social network distribution system posts the selected news articles to pages of followers of the brand.

12. The system of claim 11, wherein followers of the brand comprise individuals who have joined, followed, liked, or subscribed to a brand page.

13. The system of claim 11, wherein the plurality of brand attributes comprise a plurality of desired attributes for the brand.

14. The system of claim 11, wherein the plurality of news articles comprise text and photos.

15. The system of claim 11, wherein news articles corresponding to particular brand attributes are manually selected.

16. The system of claim 11, wherein news articles address topics not directly related to the brand.

17. The system of claim 11, wherein particular news articles are identified based not only on correspondence to particular brand attributes but effectiveness in portraying the brand attributes to a particular demographic profile.

18. The system of claim 17, wherein different news articles are selected for different groups of people for the same brand.

19. The system of claim 11, wherein the plurality of brand attributes are identified by a company.

20. A computer readable medium, comprising:
computer code for identifying a plurality of brand attributes associated with a brand;
computer code for receiving a plurality of news articles;
computer code for sending the plurality of brand attributes and the plurality of news articles over a network to a news article and brand attribute correlation system, wherein the news article and brand attribute correlation system identifies particular news articles corresponding to particular brand attributes;
computer code for sending selected news articles to a news media social network distribution system, wherein the news article social network distribution system posts the selected news articles to pages of followers of the brand.
